(19) United States
(12) Patent Application Publication
(10) Pub. No.: US 2015/0302196 A1
(43) Pub. Date: Oct. 22, 2015

(54) Local System Health Assessment

(71) Applicant: Microsoft Corporation, Redmond, WA (US)

(72) Inventors: Gopinathan Kannan, Redmond, WA (US); Octavian T. Ureche, Bellevue, WA (US); Kinshumann Kinshumann, Redmond, WA (US); Vishal Agarwal, Kirkland, WA (US)

(73) Assignee: Microsoft Corporation, Redmond, WA (US)

(21) Appl. No.: 14/254,187

(22) Filed: Apr. 16, 2014

(51) Int. Cl. G06F 21/56; G06F 21/57

(52) U.S. Cl. CPC G06F 21/562; G06F 21/57; G06F 2221/033

(57) ABSTRACT

Techniques for local system health assessment are described. In at least some embodiments, a health assessment can be performed by an isolated security environment that resides locally on a system without requiring a network connection and/or access to a remote attestation service. In at least some embodiments, a health assessment ascertains whether modules that reside on a system have been altered such that the modules may be considered unsafe. For example, a known safe list is generated that includes measurements of known safe versions of modules that may be compared to current measurements of the modules to determine whether the modules have been altered. Health policies may be employed to specify various rules and parameters for performing system health assessments.

### BACKGROUND

In today's digital environment, protecting computing resources from unauthorized access is increasingly important. For instance, malicious entities often attempt to gain unauthorized access to computing resources by infecting devices with malicious code, e.g., malware. Malware is constantly evolving in its sophistication and is thus becoming more difficult to detect on an infected machine.

One way of detecting malware on a device is through the process of attestation. Generally, attestation attempts to verify the health status of computing device components, such as modules included as part of an operating system. For instance, an attestation process may compare a signature and/or measurement for a known trusted version of a module to a current version of the module to determine whether the module has been altered. Alteration of module code, for example, may indicate that the module has been infected by malware, and thus cannot be trusted. Failing an attestation process, for instance, may indicate that a module has been altered with potentially malicious intent.

Many current attestation processes, however, rely on a network-based attestation server to implement attestation procedures. Thus, such attestation processes may not be available in offline scenarios, and may cause malware that resides on an infected device to go undetected.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for local system health assessment are described. In at least some embodiments, a health assessment can be performed by an isolated security environment that resides within a system. For instance, utilizing a local security environment enables health assessments to be performed locally and without requiring a network connection and/or access to a remote attestation service.

In at least some embodiments, a health assessment ascertains whether modules that reside on a system have been altered. For example, a module may be altered when it is infected with malicious code, such as malware. An altered module may indicate an unsafe condition for a system, e.g., that system security is compromised by the presence of malicious code.

According to one or more embodiments, a known safe list is generated that includes measurements of known safe versions of modules. A “measurement” refers to a way of identifying and/or characterizing a particular module, examples of which are detailed below. In various scenarios, a measurement of a module can be compared to a measurement of a known safe version of the module to ascertain whether the module is safe to be executed.

According to one or more embodiments, health policies are employed to specify various rules and parameters for performing system health assessments. Health policies, for instance, may specify how module measurements are to be performed, how a health assessment is to be issued based on a particular measurement comparison, how to deal with unsafe modules, how a security environment may be updated, and so forth. Thus, various aspects of health assessment procedures can be policy driven to suit a variety of different assessment scenarios. Further, health policies may be customized and/or combined to accommodate different system scenarios.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more embodiments.

FIG. 2 is a flow diagram that describes steps in a method for generating a system health assessment in accordance with one or more embodiments.

FIG. 3 is a flow diagram that describes steps in a method for provisioning a security environment in accordance with one or more embodiments.

FIG. 4 is a flow diagram that describes steps in a method for capturing system module measurements in accordance with one or more embodiments.

FIG. 5 is a flow diagram that describes steps in a method for capturing application module measurements in accordance with one or more embodiments.

FIG. 6 is a flow diagram that describes steps in a method for performing a health assessment in accordance with one or more embodiments.

FIG. 7 is a flow diagram that describes steps in a method for ascertaining whether and/or how to update a known safe list in accordance with one or more embodiments

FIG. 8 illustrates an example system and computing device as described with reference to FIG. 1, which are configured to implement embodiments of techniques described herein.

### DETAILED DESCRIPTION

Overview

Techniques for local system health assessment are described. In at least some embodiments, a health assessment can be performed by an isolated security environment that resides within a system. Generally, an isolated security environment refers to a functionality that is protected from general system access, such as a protected hardware and/or firmware environment. An isolated security environment, for instance, represents a tamper-resistant environment in which code can be safely executed. Thus, various components utilized in health assessments can be protected from unauthorized tampering by being situated within the isolated security environment. Further, utilizing a local security environment enables health assessments to be performed locally and without requiring a network connection and/or access to a remote attestation service.

In at least some embodiments, a health assessment ascertains whether modules that reside on a system have been altered. For example, a module may be altered when it is infected with malicious code, such as malware. An altered module may indicate an unsafe condition for a system, e.g., that system security is compromised by the presence of malicious code. Generally, “module” refers to portions of executable code, such as portions of applications, services, operating system modules, processes, various binaries and/or executables, and so forth.

A health assessment may be performed in response to a variety of different events. Examples of such events include a system boot process, a module being loaded, a request for access to privileged data (e.g., user credentials), a request for access to a privileged resource (e.g., a network connection), a request to participate in a high-value transaction (e.g., authentication with a commerce server), and so forth. Thus, in at least some embodiments, health assessments may be performed “on-demand” and in response to different events.

According to one or more embodiments, a known safe list is generated that includes measurements of known safe versions of modules. A “measurement” refers to a way of identifying and/or characterizing a particular module, examples of which are detailed below. In various scenarios, a measurement of a module can be compared to a measurement of a known safe version of the module included in the known safe list. If the measurements match, the module may be determined to be safe, e.g., not altered due to infection with malware. Otherwise, if the measurements don't match, the module may be determined to be unsafe, e.g., possibly infected with malware. In at least some embodiments, activities of an unsafe module can be restricted in various ways. For instance, execution of an unsafe module may be prevented, and/or access to privileged data and/or privileged resources by the unsafe module may be denied.

According to one or more embodiments, health policies are employed to specify various rules and parameters for performing system health assessments. Health policies, for instance, may specify how module measurements are to be performed, how a health assessment is to be issued based on a particular measurement comparison, how to deal with unsafe modules, how a security environment may be updated, and so forth. Thus, various aspects of health assessment procedures can be policy driven to suit a variety of different assessment scenarios. Further, health policies may be customized and/or combined to accommodate different system scenarios. For instance, trusted and secure processes may be implemented for enabling health policies to be customized.

In the following discussion, an example environment is first described that is operable to employ techniques described herein. Next, a section entitled “Health Policies” describes some example implementations and attributes of health policies in accordance with one or more embodiments. Following this, a section entitled “Example Procedures” describes some example methods for local system health assessment in accordance with one or more embodiments. Finally, a section entitled “Example System and Device” describes an example system and device that are operable to employ techniques discussed herein in accordance with one or more embodiments.

Example Environment

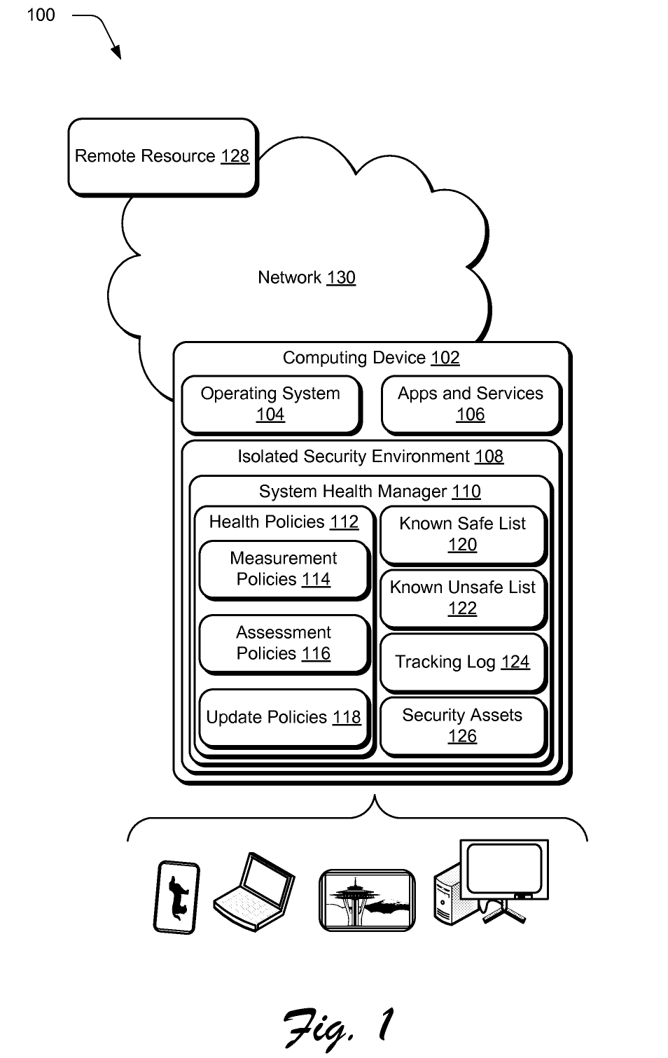

FIG. 1 is an illustration of an environment 100 in an example implementation that is operable to employ techniques for local system health assessment discussed herein. Environment 100 includes a computing device 102 which can be embodied as any suitable device such as, by way of example and not limitation, a smartphone, a tablet computer, a portable computer (e.g., a laptop), a desktop computer, a wearable device, and so forth. One of a variety of different examples of a computing device 102 is shown and described below in FIG. 8.

The computing device 102 includes a variety of different functionalities that enable various activities and tasks to be performed. For instance, the computing device 102 includes an operating system 104 and applications and services (apps and services) 106. Generally, the operating system 104 is representative of functionality for abstracting various system components of the computing device 102, such as hardware, kernel-level modules and services, and so forth. The operating system 104, for instance, can abstract various the components to the apps and services 106 to enable interaction between the components and the apps and services 106.

The apps and services 106 are representative of functionality to enable various tasks and activities to be performed via the computing device 102, such as word processing, web browsing, email, social media, enterprise tasks, and so forth. The apps and services 106 may be installed locally on the computing device 102 to be executed via a local runtime environment, and/or may represent portals to remote functionality, such as cloud-based services, web apps, and so forth.

The computing device 102 further includes an isolated security environment (ISE) 108, which is representative of a portion of the computing device 102 that protected from general access by most or all other functionalities of the computing device 102. The ISE 108 can be implemented in various ways, such as a separate, dedicated hardware environment (e.g., a dedicated chip), a subdivided portion of an existing hardware environment (e.g., a sub-portion of a central processing unit (CPU)), a protected firmware environment, and so forth.

As further detailed herein, under typical operating conditions, interaction with the ISE 108 by functionalities outside of the ISE 108 is limited to particular types of interactions. For instance, functionalities outside of the ISE 108 (e.g., the operating system 104 and the apps and services 106) may be permitted to submit input to the ISE 108 and to receive output from the ISE 108, but may be prevented from reading data directly from within the ISE 108 or from performing direct write operations to the ISE 108. In some limited scenarios, however, the ISE 108 may be available for direct interactions by external functionalities, such as during an initial provisioning procedure and/or an update procedure. Further details concerning the ISE 108 are presented below.

A system health manager 110 resides within the ISE 108, and is representative of functionality to perform various aspects of techniques for local system health assessment discussed herein. In at least some embodiments, the system health manager 110 functions as an attestation engine for performing system health assessments for the computing device 102. For instance, techniques discussed herein may be performed by the system health manager 110 and independent of the operating system 104. Performing health assessments within the ISE 108 reduces the likelihood of tampering with aspects of a health assessment process.

The system health manager 110 includes health policies 112, which in turn include measurement policies 114, assessment policies 116, and update policies 118. Generally, the health policies 112 specify different rules, parameters, and instructions for implementing techniques for local system health assessment. Further details concerning the health policies 112 are discussed below.

The system health manager 110 further includes a known safe list 120 and a known unsafe list 122. According to various embodiments, the known safe list 120 is representative of functionality to track measurements for known safe versions of different modules. As used herein, the term “module” generally refers to portions of executable code, such as applications, services, operating system modules, processes, various binaries and/or executables, and so forth.

Generally, a “measurement” refers to a way of identifying and/or characterizing a particular module. Examples of measurements include hash values generated from module code, module signatures, encrypted versions of modules and/or portions of modules, and so forth. According to various implementations, a “known safe version” of a module represents a version of a module that is known to be trusted and/or safe to be executed on a computing device. A module may be determined to be “known safe” by an entity that generates the module, such as an OS developer, an application developer, and so forth. As used herein, safety may refer to safety in terms of system security, and may also concern safety with regard to ensuring that a module is relatively free from errors in code (e.g., bugs) that may cause the module to behave in an unintended way. Thus, in at least some embodiments, the known safe list 120 represents a list of measurements for modules that are known to be free from malware infection and free from significant errors in code.

The known unsafe list 122 is representative of functionality to track measurements for known unsafe versions of different modules. Known unsafe modules, for instance, may represent modules that are known to be infected with malware, and/or modules that are known to have significant code errors, e.g., bugs. In at least some embodiments, the known unsafe list 122 may be leveraged to identity unsafe modules and to prevent the unsafe modules from being loaded into memory and/or executed.

The system health manager 110 further includes a tracking log 124, which is representative of functionality to track and record measurements for modules in different ongoing scenarios. For instance, measurements for modules that are loaded as part of a boot process of the computing device 102, such as modules of the operating system 104, can be stored as part of the tracking log 124. Further, measurements for modules that are loaded as part of loading and/or executing the apps and services 106 may also be stored as part of the tracking log 124.

Measurements may also be captured during runtime scenarios and stored as part of the tracking log 124, such as for modules of the operating system 104, the apps and services 106, other processes and/or functionalities of the computing device 102, and so forth. As further detailed below, a measurement for a module stored in the tracking log 124 can be compared to a measurement for a version of the module stored in the known safe list 120 and/or the known unsafe list 122 to ascertain whether the module is safe or unsafe to be loaded and/or executed by the computing device 102.

The system health manager 110 further includes security assets 126, which are representative of different types of security-related information that may be leveraged to verify the identities of certain entities, the authenticity and/or trusted status of various types of data, and so forth. Examples of the security assets 126 include security keys (e.g., public keys, private keys, and so forth), security certificates, encryption and decryption algorithms, and so forth. Further details concerning ways in which the security assets 126 may be configured and leveraged are discussed below.

The environment 100 also includes a remote resource 128, which is representative of various types of resources that may be communicatively accessible to the computing device 102 via a network 130. Examples of the remote resource 128 include a website, a content store, a network-hosted application (e.g., a web app), a network-hosted service, a social media platform, and so forth. Generally, the remote resource 128 represents any type of resource that the computing device 102 may access to interact with, obtain, and/or access content, services, and so forth. The remote resource 128 can be implemented via various types and/or combinations of computing devices, examples of which are described below in FIG. 8.

The remote resource 128 can provide various types of content to the computing device 102, such as applications, modules for the operating system 104, updates for the operating system 104 and the apps and services 106, media content, and so forth. In at least some embodiments, when the remote resource 128 provides an instance of content to the computing device 102, the remote resource 128 may also provide a known safe measurement for the instance of content. The system health manager 110 can store the known safe measurement as part of the known safe list 120, and can use the known safe measurement to verify the integrity off the instance of content, such as part of a runtime loading and/or execution of the content.

The one or more networks 130 are representative of networks via which various entities of the environment 100 may communicate. The network(s) 130 may assume a variety of different configurations, such as a local area network (LAN), a wide area network (WAN), the Internet, and so on. In at least some embodiments, functionalities discussed with reference to the environment 100 and/or other portions of the discussion herein may be implemented in a distributed environment (e.g., “over the cloud”), as further described in relation to FIG. 8.

Having described an example environment in which the techniques described herein may operate, consider now a discussion of health policies in accordance with one or more embodiments.

Health Policies

This section describes some example implementations and attributes of health policies, such as the health policies 112 introduced above. For purpose of example only, the policies are described using various entities introduced above with reference to environment 100.

Generally, health policies specify different rules, parameters, and instructions for implementing techniques for local system health assessment discussed herein. While a variety of different health policies may be generated and utilized, the following are some examples of particular types and instances of health policies in accordance with different embodiments.

(1) Measurement policies 114—According to one or more embodiments, measurement policies specify rules and parameters for capturing measurements of different modules. Examples of attributes and parameters that can be considered in configuring measurement policies include:

a. Module type—an example measurement policy can specify that measurements for modules classified as particular types of modules are to be collected, while measurements for modules not classified as the particular types of modules are not to be collected. While any arbitrary class can be defined for classifying module types, some particular classifications may be useful in protecting computing resources.

For instance, a class of modules can be defined for modules that request access to privileged data. Examples of privileged data include user credentials (e.g., usernames, passwords, user identifiers, and so forth), security keys, machine-based secrets, and other data and information that is protected from general access. A module associated with an email service, for instance, may request user credentials such that the service can retrieve user emails. Thus, the module may be classified as requesting access to privileged data such that measurements for the module are collected.

Another class of modules may be defined for modules that request access to network resources, such as a network connection. For instance, a web browser or other web application may be classified as requesting and/or using a network connection, and thus measurements for the application may be collected.

Another class of modules may be defined for modules that access enterprise data, such as client files, enterprise metrics, employee files, and so forth. For instance, a spreadsheet program that gathers and calculates various enterprise-related data can be characterized as a module that accesses enterprise data. According to one or more implementations, data may be tagged as “enterprise data” using various techniques. For instance, enterprise data may be tagged by encrypting the data with a key that is specific to a particular enterprise entity.

b. Module ID—another example measurement policy can specify that measurements for specifically-identified modules are to be collected. The policy, for instance, can identify particular applications, processes, and/or services for which measurements are to be collected. The policy may include a default listing of particular modules, and/or may be customized. For instance, a system administrator and/or other user may configure the policy to identify particular modules that are to be measured.

c. User Type—another example measurement policy can specify that for particular user types, measurements for particular modules and/or module types are to be collected. The policy, for instance, can specify that for users with permission to access sensitive data (e.g., administrators), measurements for particular applications, processes, and/or services are to be collected. The policy may further specify that for users with less extensive permissions (e.g., standard users, guests, and so forth), measurements for a smaller set of modules are to be collected.

The measurement policies discussed above are presented for purpose of example only, and it is to be appreciated that a wide variety of other measurement policies not specifically discussed herein may be employed in accordance with one or more embodiments. Further, different measurement policies may be combined in different ways to define a set of measurement policies that can be applied.

(2) Assessment policies 116—According to one or more embodiments, assessment policies specify rules and parameters for assessing system health based on various detected system conditions. For instance, assessment policies may specify a particular condition of a module (e.g., safe, unsafe, and so forth) based on a comparison of a current module measurement with a known safe measurement for the module. Assessment policies may further specify allowed actions and/or permissions for a module based on a condition of the module. The following are just a few examples of some assessment policies that may be employed.

a. Strict assessment—one example assessment policy may specify that if a measurement for a current version of a module does not match a known good measurement for the module, the module is considered unsafe and is not to be loaded and/or executed. When such a policy is in force and a module is determined to be unsafe, an attempt to load and/or execute the module may fail, e.g., may cause an error condition that prevents the module from loading and/or executing.

b. Conditional assessment—another example assessment policy may specify that if a measurement for a current version of a module does not match a known good measurement for the module, the module is considered unsafe and/or untrusted, but may be loaded and/or executed with certain limitations. For instance, the policy may limit the access permissions for the module such that the module is permitted to execute but is not permitted to access privileged data (e.g., user credentials) and/or privileged computing resources, such as a network connection and/or system level components.

Additionally or alternatively, the policy may specify that the module is permitted to be loaded and/or executed, but that certain functionality of the module is to be disabled. For instance, a web browser that is determined to be unsafe may be permitted to load and browse the Internet, but may not be allowed to access user credentials and/or prompt a user to input their credentials.

c. Module-specific assessment—another example assessment policy specifies different module conditions and/or permissions for different types and/or instances of modules. For example, the policy may specify that if a measurement matching failure occurs for some specific modules/modules types, the modules may still be loaded and/or executed. This may be applied, for instance, to modules that don't access sensitive data and/or resources. The policy may further specify that if a measurement matching failure occurs for other specific modules/module types, the modules may not be loaded and/or executed. This may be applied, for instance, to modules that access sensitive data and/or resources.

As with others of the health policies discussed herein, the assessment policies discussed above may be combined to provide customized policies to suit various scenarios and operating parameters. For instance, a module-specific assessment policy may be combined with a conditional assessment policy to give limited rights and/or permissions to specific modules/modules types that experience a measurement matching failure during an assessment procedure.

(3) Update policies 118—According to one or more embodiments, update policies specify rules and parameters for updating various attributes of a security environment. For instance, update policies may specify under what conditions the known safe list 120 and/or the known unsafe list 122 may be updated, and how the respective lists are to be updated. Assessment policies may further specify allowed actions and/or permissions for a module based on a source and/or attribute of the module. The following are just a few examples of some update policies that may be employed.

a. Open update—one example update policy may specify that when a new module is installed, such as a new application, an update to an existing application and/or operating system, and so forth, a measurement for the module is to be captured and stored as part of a known safe list. Thus, the policy may imply that when a module is first received and/or installed, the module is assumed to be in a safe state. This policy, however, may be subject to certain conditions. For instance, the policy may specify that a new module must pass certain security screening procedures before being installed and added to a known safe list, such as antivirus scanning, antimalware scanning, and so forth. In at least some embodiments, the policy is source agnostic and does not screen modules based on their source.

b. Selective update—this update policy may specify that certain types and/or instances of modules may be measured and added to a known safe list when the modules are first installed and/or executed. The policy, for instance, may identify specific modules, such as based on an application and/or module identifier. Additionally or alternatively, the policy may specify particular types and/or classes of modules that may be added to a known safe list. Examples of different module classes are described above. For instance, modules within a particular class may be measured and added to a known safe list, whereas modules not categorized within that class may not.

c. Trusted source—this update policy may specify that modules originating and/or received from a trusted source may be measured and added to a known safe list, whereas modules originating and/or received from an unknown and/or untrusted source may not. For instance, the policy may specify that modules from a source that has a trusted security certificate (e.g., a secure sockets layer (SSL) certificate, a transport layer security (TLS) certificate, and so forth) are considered to be safe and thus may be measured and added to a known safe list. Conversely, a module from an unknown and/or untrusted source may be considered unsafe and may not be loaded and/or executed.

The health policies discussed above are presented for purpose of example, and it is to be appreciated that a wide variety of other types and instances of health policies may be configured and employed in accordance with various embodiments. Further, health policies may be combined in various ways to provide for custom sets of health policies. Thus, different types and instances of health policies may be defined, configured, and/or combined to suit different operating scenarios and parameters.

Having described some example health policies which may be employed according to techniques described herein, consider now a discussion of some example procedures in accordance with one or more embodiments.

Example Procedures

The following section describes some example procedures for local system health assessment in accordance with one or more embodiments. The example procedures may be employed in the environment 100 of FIG. 1, the system 800 of FIG. 8, and/or any other suitable environment. In at least some embodiments, steps described for the various procedures are implemented automatically and independent of user interaction. Further, some or all of the steps (with the possible exception of the provisioning and update procedures) may be performed locally on a device, e.g., independent of and/or without a network connection.

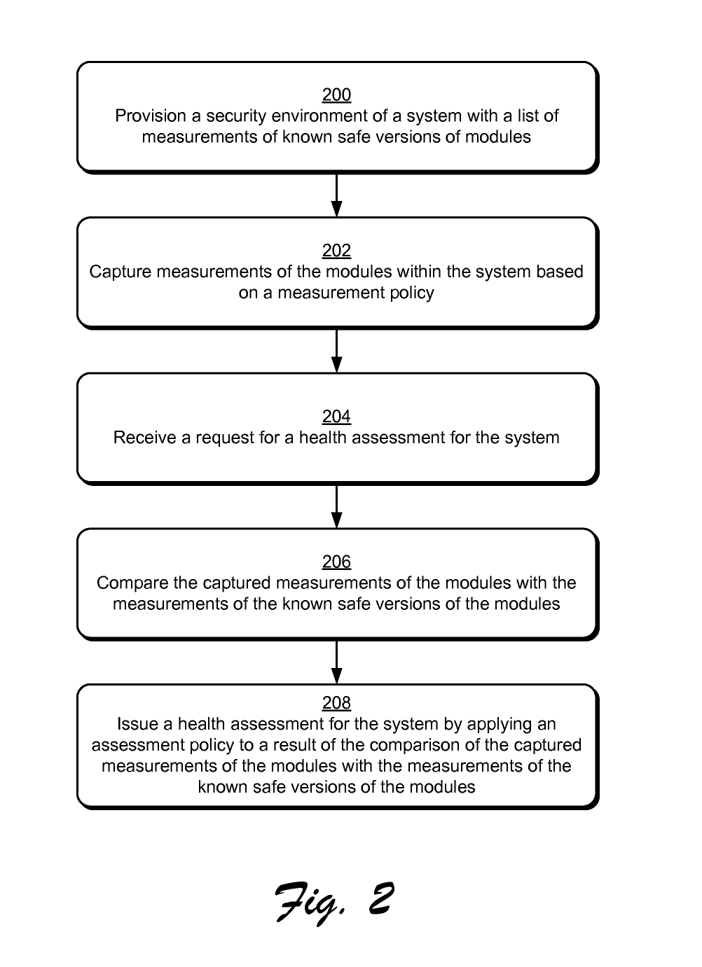

FIG. 2 is a flow diagram that describes steps in a method in accordance with one or more embodiments. The method, for instance, describes an example way of generating a system health assessment in accordance with one or more embodiments. According to one or more implementations, steps described in the method correspond to interactions between the operating system 104 and the ISE 108.

Step 200 provisions a security environment of a system with a list of measurements of known safe versions of modules. For example, the known safe list 120 of the ISE 108 can be provisioned with measurements (e.g., hash values) of known safe modules. In at least some embodiments, provisioning includes configuring a table or other data structure with module identifiers for modules and corresponding measurements for the respective modules. A detailed method for provisioning a security environment is presented below.

In at least some embodiments, the system can be rebooted after being provisioned to enable various provisioning settings to be applied, e.g., prior to proceeding to the following steps. This is not a requirement, however, and the method may proceed without a reboot.

Step 202 captures measurements of the modules within the system based on a measurement policy. The measurements, for instance, can be captured during a system boot procedure and/or during a system runtime. In at least some embodiments, measurements may be captured by the operating system 104 and submitted to the system health manager 110 to be written to the tracking log 124.

The modules may include system-level components, such as operating system 104 modules. Alternatively or additionally, the modules may include other components, such as modules from the apps and services 106. In at least some embodiments, the measurements may be collected by generating hash values of code of the modules and storing the hash values as part of a log, e.g., the tracking log 124. As referenced above, however, other types of measurements may be employed, e.g., as an addition or alternative to hash values.

Examples of different measurement policies that may be employed are discussed above. A particular measurement policy that is applied, for instance, may include a specific instance of a measurement policy and/or a combination of different measurement policies. Generally, the measurement policy may specify which modules are to be measured. In at least some embodiments, measurements are not collected for modules that do not fall within an applied measurement policy. A detailed method for collecting module measurements is discussed below.

Step 204 receives a request for a health assessment for the system. For instance, the request can be received in response to a particular event. Examples of such an event include a loading of a particular module, detecting a request for access to privileged information, such as user credentials, a security key, a security certificate, and so forth. The event may be related to a particular module for which measurements are tracked, and/or may relate to a different module or functionality. In at least some embodiments, a request for a health assessment includes a request for a health assessment for a particular module in response to the module requesting access to privileged information.

Another example of an event that can initiate a request for a health assessment is a request for access to a privileged resource. Examples of a privileged resource include hardware and/or firmware resources, such as a network connection, an output device, an input device, a location-sensing device and/or functionality, and so forth.

A health assessment may also be requested based on an indication that a system may be infected with malicious code. For instance, if a malicious code signature is detected and/or a problem with system performance is detected, a system health assessment can be requested, e.g., automatically and independent of user input.

A health assessment may be requested for a variety of other reasons, such as a periodic procedure for ascertaining system health, an express request from a user or other entity for a system health assessment, and so forth.

Step 206 compares the captured measurements of the modules with the measurements of the known safe versions of the modules. Measurements of the modules stored in the tracking log 124, for instance, are compared with measurements of known safe versions of the modules from the known safe list 120. The comparison can be performed by matching modules IDs from the tracking log 124 to module IDs in the known safe list 120, and then comparing measurements for matching modules IDs. For example, comparing measurements includes comparing a hash value for a known safe version of the module with a hash value for the module from the tracking log 124.

Step 208 issues a health assessment for the system by applying an assessment policy to a result of the comparison of the captured measurements of the modules with the measurements of the known safe versions of the modules. The health assessment, for instance, can depend on whether the different measurements match, and may also depend on particular rules and/or parameters specified by the health policy for dealing with matches and mismatches between measurements. A detailed method for issuing a health assessment is discussed below.

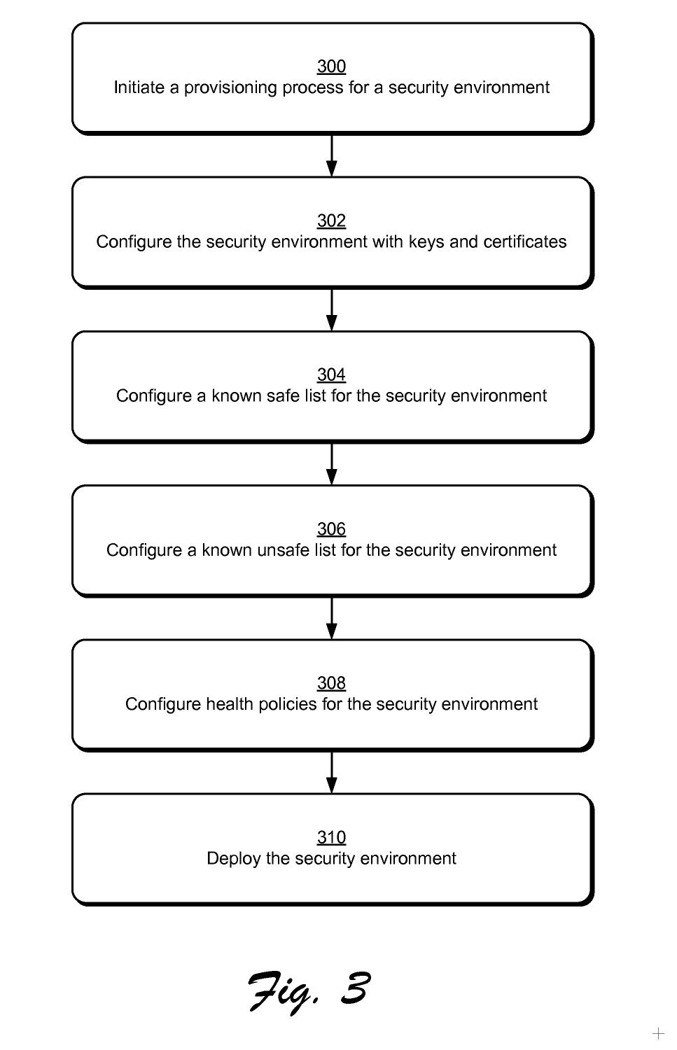

FIG. 3 is a flow diagram that describes steps in a method in accordance with one or more embodiments. The method, for instance, describes an example way of provisioning a security environment (e.g., the ISE 108) in accordance with one or more embodiments. For example, the method describes an example implementation of step 200 of the method discussed above with reference to FIG. 2.

The different assets and components transferred during a provisioning process can be received and/or retrieved from a variety of different sources, such as a source that is local to a computing device, e.g., a computer-readable storage medium that is operably attached to the computing device. Alternatively or additionally, assets and components can be received from a remote resource, such as the remote resource 128.

Step 300 initiates a provisioning process for a security environment. According to various embodiments, a provisioning process can be initiated in a variety of different scenarios. For instance, a provisioning process can be initiated as part of an out-of-box experience, e.g., when a device is first powered on and configured. A provisioning process may also be initiated as part of a device update and/or reconfiguration process, such as when a new operating system is installed and/or when an existing operating system is updated.

A provisioning process may also be initiated in response to installation and/or activation of a security environment in a system. For instance, consider that dedicated security environment hardware and/or firmware is installed on an existing computing device. In response to the installation, a provisioning process can be initiated to configure the security environment for operation on the computing device.

Step 302 configures the security environment with keys and certificates. For instance, different security-related keys and certificates can be transferred to and saved within the security environment. The keys and certificates can be utilized by the security environment for various purposes, such as encrypting and/or decrypting information, verifying the authenticity and/or trusted status of data, and so forth. Example scenarios in which the keys and certificates may be utilized are discussed elsewhere herein.

Step 304 configures a known safe list for the security environment. As detailed herein, a known safe list generally includes measurements for known safe versions of different modules that are installed on and/or interact with a computing system.

A known safe list may be configured in a variety of ways. For instance, the known safe list may be partially or wholly retrieved from a local data storage resource, such as a data storage medium from which an operating system and/or applications are read. With reference to an operating system, for example, an operating system developer can provide both operating system modules and a known safe list for the operating system modules as part of an installable package on a data storage medium. A similar situation can apply for applications, services, and so forth.

Alternatively or additionally, a known safe list can be received from a remote resource, such as an application store, an anti-malware developer, and so forth. For instance, a known safe list can be downloaded along with modules for an operating system, an application, and/or other content. Thus, in at least some implementations, a known safe list may be pre-generated and/or generated out-of-band, and then provided to a computing device.

As another alternative or additional embodiment, a local resource (e.g., an operating system) can generate measurements for modules and submit the measurements to a security environment for storage as part of a known safe list. For instance, when an operating system and/or application is first installed or initiated on a device, the operating system can generate measurements for its respective modules and submit the measurements to a security environment for storage as part of a known safe list. A similar procedure may also be performed when a security environment is first installed and/or activated on a device.

These scenarios for receiving a known safe list are presented for purpose of example, and a known safe list may be provided and/or received in a variety of other ways not expressly discussed herein.

Step 306 configures a known unsafe list for the security environment. The known unsafe list, for instance, includes measurements for versions of modules that are known to be unsafe, such as versions of modules known to be infected with malware, modules associated with an untrusted source, versions of modules with code that is known to include significant errors (e.g., bugs), and so forth. The known unsafe list can be received according to according to a variety of different scenarios, such as along with a known safe list that is received as discussed herein. In at least some embodiments, the step of receiving a known unsafe list is considered optional.

Step 308 configures health policies for the security environment. Examples of different health policies that can be configured for a security environment are discussed elsewhere herein.

Health policies may be configured in a variety of ways. For instance, health policies may be received as pre-configured policies, such as from a device manufacturer, an operating system developer, an application developer, and so forth. Health policies, for example, may be received as part of and/or along with a package that includes operating system modules, application modules, and so forth.

Alternatively or additionally, health policies may be received as policy templates that include policy logic with at least some blank values that can be configured to fit different implementation scenarios, such as by information technology (IT) personnel, end users, and so forth. As yet another alternative or additional embodiment, health policies may be generated ab initio for particular scenarios, such as by IT personnel, end users, and so forth. Health policies may be received and configured in a variety of other ways not expressly discussed herein.

Step 310 deploys the security environment. The security environment, for instance, can go “online” and begin collecting measurements for modules that are loaded and/or executed, and can begin responding to attestation requests. Further, the security environment can begin applying its various health policies.

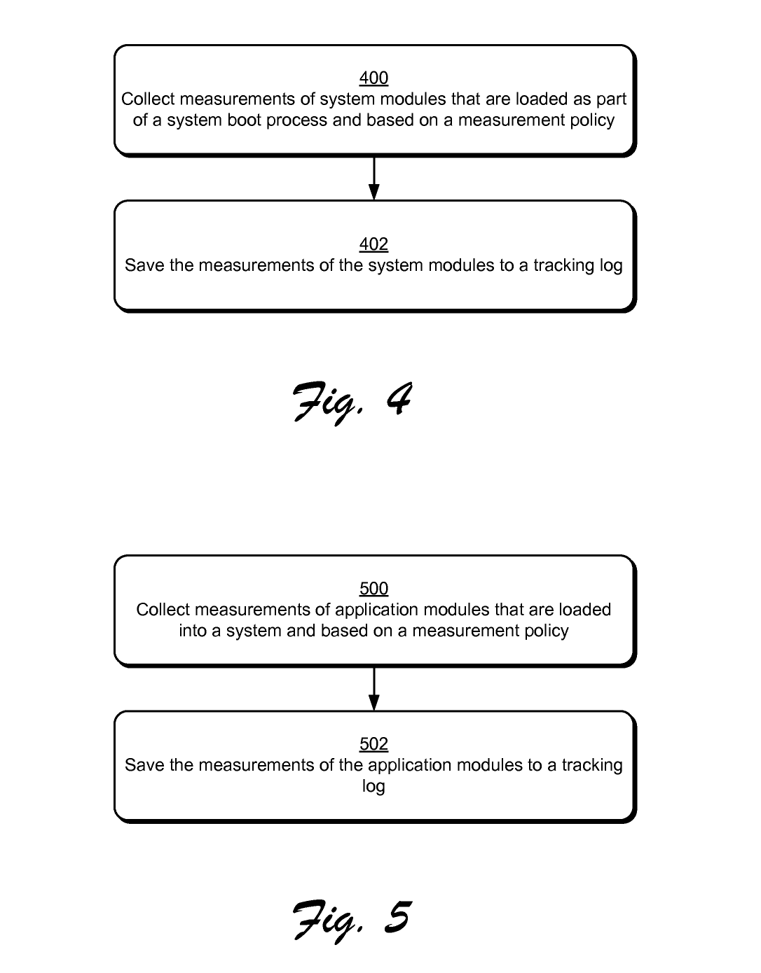

FIG. 4 is a flow diagram that describes steps in a method in accordance with one or more embodiments. The method, for instance, describes an example way of capturing system module measurements in accordance with one or more embodiments. For example, the method describes an example implementation of step 202 of the method discussed above with reference to FIG. 2.

Step 400 collects measurements of system modules that are loaded as part of a system boot process and based on a measurement policy. For instance, measurements of operating system modules and/or other system-level modules can be collected, such as in response to the modules being loaded from storage into memory as part of a system boot process. In at least some embodiments, collecting measurements can including generating hash values of module code.

As referenced above, a measurement policy can specify various rules and parameters for capturing measurements. For instance, a measurement policy can be applied to specify for which system modules measurements are to be collected, how frequently measurements are to be collected, what types of measurements are to be collected, and so forth. Examples of different measurement policies that can be applied are discussed above.

In at least some embodiments, the measurements are generated by an operating system and/or other functionality that is external to a security environment. Alternatively or additionally, the measurements can be generated by functionality from within a security environment.

Step 402 saves the measurements of the system modules to a tracking log. The system health manager 110, for example, writes the measurements to the tracking log 124. According to one or more embodiments, the measurements are linked in the tracking log to a module ID that enables the measurements to be retrieved via the module ID.

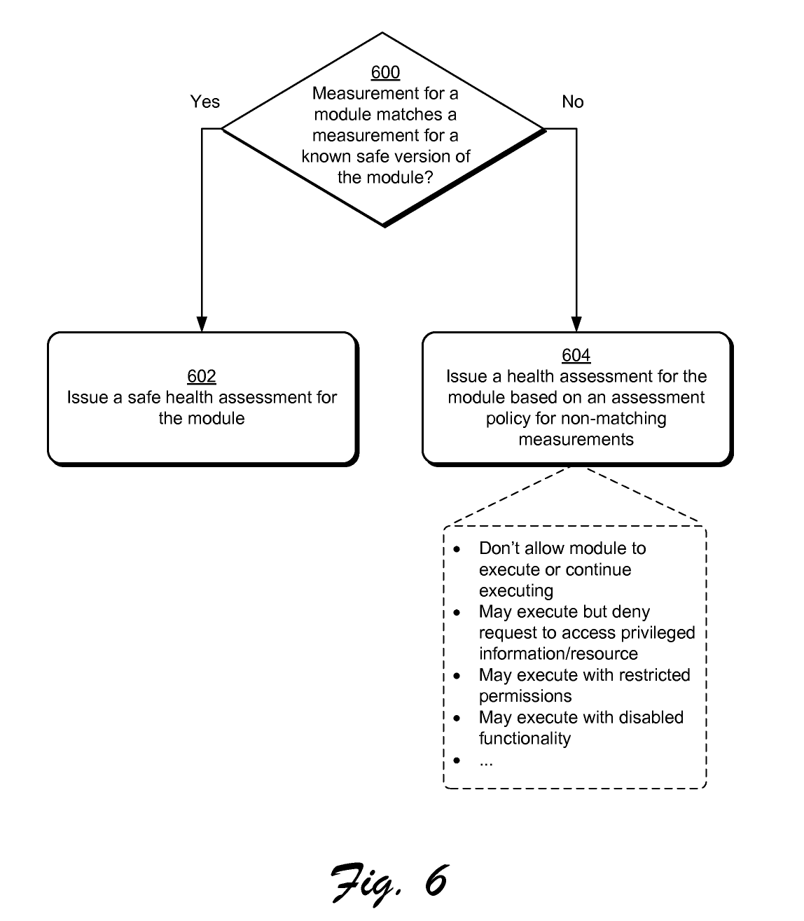

FIG. 5 is a flow diagram that describes steps in a method in accordance with one or more embodiments. The method, for instance, describes an example way of capturing application module measurements in accordance with one or more embodiments. For example, the method describes an example implementation of step 202 of the method discussed above with reference to FIG. 2.

Step 500 collects measurements of application modules that are loaded into a system and based on a measurement policy. For instance, measurements of modules for applications and/or services (e.g., the apps and services 106) can be collected, such as in response to the modules being loaded from storage into memory. In at least some embodiments, collecting measurements can including generating hash values of module code.

As referenced above, a measurement policy can specify various rules and parameters for capturing measurements. For instance, a measurement policy can be applied to specify for which application/service modules measurements are to be collected, how frequently measurements are to be collected, what types of measurements are to be collected, and so forth. Examples of different measurement policies that can be applied are discussed above.

In at least some embodiments, the measurements are generated by an operating system and/or other functionality that is external to a security environment. Alternatively or additionally, the measurements can be generated by functionality from within a security environment.

Step 502 saves the measurements of the application modules to a tracking log. The system health manager 110, for example, writes the measurements to the tracking log 124. According to one or more embodiments, the measurements are linked in the tracking log to a module ID that enables the measurements to be retrieved via the module ID.

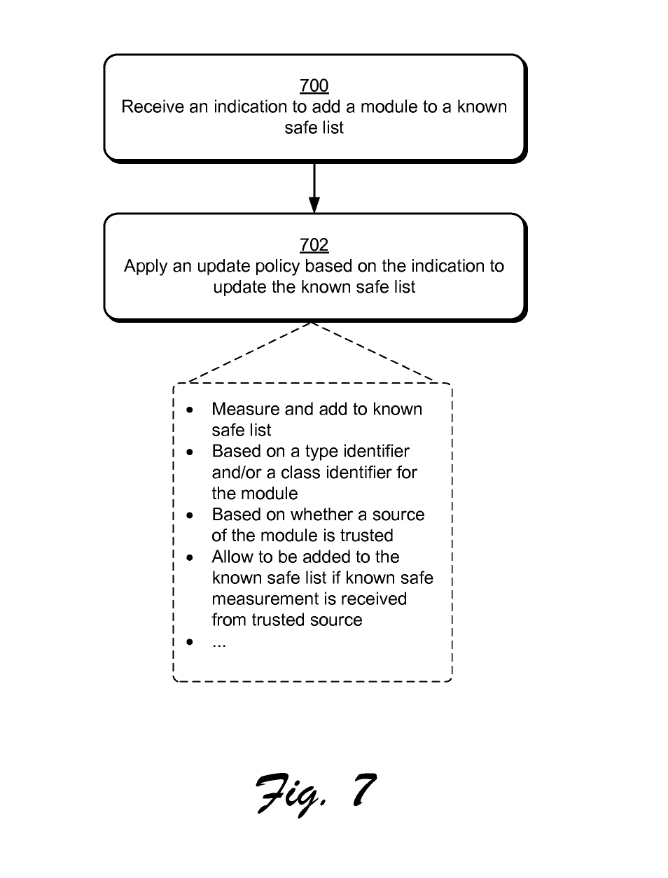

FIG. 6 is a flow diagram that describes steps in a method in accordance with one or more embodiments. The method, for instance, describes an example way of performing a health assessment in accordance with one or more embodiments. For example, the method describes an example implementation of step 208 of the method discussed above with reference to FIG. 2.

Step 600 ascertains whether a measurement for a module matches a measurement for a known safe version of the module. The system health manager 110, for instance, compares a measurement for a module from the tracking log 124 with a measurement for a known safe version of the module from the known safe list 120.

If the measurement for the module matches the measurement for the known safe version of the module (“Yes”), Step 602 issues a safe health assessment for the module. Based on the safe health assessment, for instance, the module may be allowed to proceed with a requested action, such as accessing privileged information, a privileged resource, and so forth. For example, the operation system 104 can receive the safe health assessment from the ISE 108, and thus may allow the module to proceed executing and performing a requested action.

If the measurement for the module does not match the measurement for the known safe version of the module (“No”), Step 604 issues a health assessment for the module based on an assessment policy for non-matching measurements. Examples of assessment policies that may be applied when measurements don't match are discussed above. As indicated here, examples of such assessments include: (1) do not allow the module to be executed or continue executing, (2) allow the module to execute but deny a request to access privileged information and/or a privileged resource, (3) allow the module to execute with restricted permissions, (4) allow the module to execute with some functionality disabled (e.g., functionality that may compromise system security), and so forth.

In at least some embodiments, an assessment policy may specify that if a measurement for a module does not match a measurement for a known safe version of the module, the measurement for the module is to be compared to a measurement for a known unsafe version of the module, e.g., from the known unsafe list 122. If the measurements match, a health assessment can be issued that the module is known to be unsafe. Thus, the system may perform a remedial procedure, such as deleting the module, sanitizing malicious code from the module, downloading a known safe version of the module, debugging the module, and so forth.

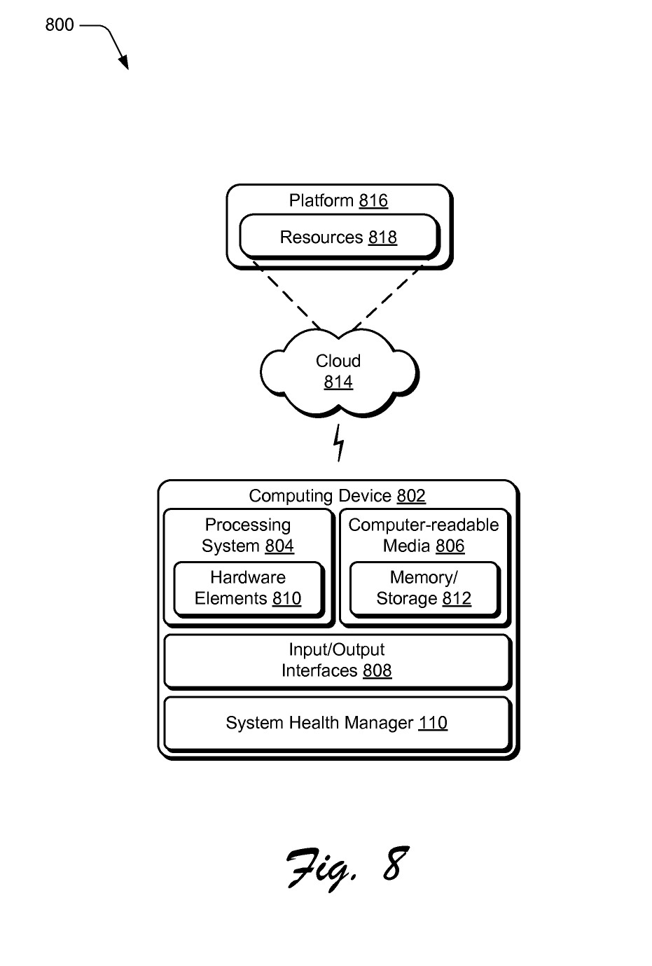

FIG. 7 is a flow diagram that describes steps in a method in accordance with one or more embodiments. The method, for instance, describes an example way of ascertaining whether and/or how to update a known safe list in accordance with one or more embodiments.

Step 700 receives an indication to add a module to a known safe list. The indication may be received in response to different events, such as an installation of a new module, an update to an existing module, and so forth.

Step 702 applies an update policy based on the indication to update the known safe list. Examples of update policies that may be applied are discussed above. As indicated here, examples of such policies include: (1) measure the module and add the measurement to the known safe list (“Open update” policy), (2) determine whether to add the module to the known safe list based on a type identifier and/or a class identifier for the module, (3) determine whether to add the module to the known safe list based on whether a source of the module is trusted (e.g., is issued by a source with a trusted certificate), (4) allow the module to be added to the known safe list if a known safe measurement is received from a trusted source (e.g., is signed with a trusted certificate), and so forth.

While embodiments are discussed herein with respect to a single module, it is to be appreciated that the various techniques and procedures can be employed to perform health assessment for multiple modules during a particular (e.g., single) health assessment procedure. Thus, techniques can be employed to ascertain an overall health status of a system with regard to the health a variety of modules that reside on and/or interact with the system.

Having discussed some example procedures for local system health assessment, consider now a discussion of an example system and device in accordance with one or more embodiments.

Example System and Device

FIG. 8 illustrates an example system generally at 800 that includes an example computing device 802 that is representative of one or more computing systems and/or devices that may implement the various techniques described herein. This is illustrated through inclusion of the system health manager 110, which may be employed to implement techniques for local system health assessment discussed herein. The computing device 802 may be, for example, a server of a service provider, an on-chip system, and/or any other suitable computing device or computing system.

The computing device 802 as illustrated includes a processing system 804, one or more computer-readable media 806, and one or more I/O interfaces 808 that are communicatively coupled and/or connected, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 are illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

Discussed herein are a number of methods that may be implemented to perform techniques discussed herein. Aspects of the methods may be implemented in hardware, firmware, or software, or a combination thereof The methods are shown as a set of blocks (e.g., steps) that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100, the system 800, and so on.

Conclusion

Techniques for local system health assessment are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
one or more processors; and
one or more computer-readable storage media storing computer-executable instructions that, responsive to execution by the one or more processors, cause the system to perform operations locally on the system, including:
capturing a measurement of a module based on one or more measurement policies that specify parameters for capturing module measurements;
receiving a request to issue a health assessment for the module;
comparing the captured measurement of the module with a measurement of a known safe version of the module; and
issuing a health assessment for the module by applying an assessment policy to a result of said comparing.

2. The system as described in claim 1, wherein the measurement of the module comprises a hash of module code, and wherein the measurement of the known safe version of the modules comprises a hash of module code for the known safe version of the module.

3. The system as described in claim 1, wherein the one or more measurement policies specify which modules of the system are to be measured.

4. The system as described in claim 1, wherein the request to issue the health assessment for the module is initiated in response to the module requesting access to privileged data.

5. The system as described in claim 4, wherein the privileged data comprises user credentials.

6. The system as described in claim 1, further comprising ascertaining that the captured measurement of the module matches the measurement of the known safe version of the module, and wherein said issuing the health assessment comprises issuing an indication that the module is safe.

7. The system as described in claim 1, further comprising ascertaining that the captured measurement of the module does not match the measurement of the known safe version of the module, and wherein said issuing the health assessment comprises issuing an indication that the module is unsafe.

8. The system as described in claim 7, wherein the assessment policy specifies that the unsafe module is to be denied access to one or more of privileged information or a privileged resource.

9. The system as described in claim 7, wherein the assessment policy specifies that the unsafe module may execute on the system with limited permissions.

10. The system as described in claim 1, wherein the operations are performed locally on the system and independent of access to a network resource.

11. A computer-implemented method, comprising:
capturing measurements of a group of modules that reside on a system based on one or more measurement policies that specify parameters for capturing module measurements on the system;
receiving a request to issue a health assessment for the system;
ascertaining whether the captured measurements of the group of modules match measurements of known safe versions of the individual modules of the group of modules; and
issuing a health assessment for the system by applying an assessment policy to a result of said ascertaining.

12. A computer-implemented method as recited in claim 11, wherein the request to issue the health assessment occurs in response to a request from one or more of the modules for access to at least one of user credentials or a privileged resource.

13. A computer-implemented method as recited in claim 11, wherein the method is performed locally on the system and independent of access to a network connection.

14. A computer-implemented method as recited in claim 11, wherein said ascertaining comprises ascertaining that at least one captured measurement of a module does not match a measurement of a known safe version of the module, and wherein the health assessment indicates that the system is in an unsafe state.

15. A computer-implemented method as recited in claim 14, wherein the assessment policy specifies that when the system is in unsafe state, user credentials are not accessible.

16. One or more computer-readable storage media having instructions stored thereon that, responsive to execution by one or more processors, cause the one or more processors to perform operations comprising:
initiating a provisioning process for a security environment that resides locally on a system, the provisioning process including:
configuring a known safe list for the security environment that includes a list of measurements of known safe versions of modules that reside on the system;
configuring health policies for the security environment that include one or more of rules or parameters for issuing a health assessment for the system; and
deploying the security environment to enable a health assessment to be performed for the system by comparing a measurement for at least one of the modules to a measurement from the known safe list for the at least one of the modules, and applying one or more of the health policies to a result of said comparing.

17. One or more computer-readable storage media as recited in claim 16, wherein the health policies comprise one or more of measurement policies that specify which of the modules are to be measured on the system, assessment policies that specify rules and parameters for assessing system health based on various detected system conditions, or update policies that specify rules and parameters for updating various attributes of the security environment.

18. One or more computer-readable storage media as recited in claim 16, wherein the provisioning process further includes configuring a known unsafe list for the security environment that includes a list of measurements of known unsafe versions of modules.

19. One or more computer-readable storage media as recited in claim 16, wherein the operations further comprise:
receiving an indication to add a module to the known safe list; and
applying an update policy from the health policies based on the indication to update the known safe list.

20. One or more computer-readable storage media as recited in claim 16, wherein the health policies are customizable via a secure process locally on the system.
